(19) United States
(12) Patent Application Publication
(10) Pub. No.: US 2002/0164397 A1
(43) Pub. Date: Nov. 7, 2002

(54) N-[N-(3, 3-DIMETHYLBUTYL)-L-ALPHA-ASPARTYL]-L-PHENYLALANINE 1-METHYL ESTER AS A SWEETENER IN CHEWING GUM

(76) Inventors: SUBBARAO V. PONAKALA, ELK GROVE VILLAGE, IL (US); JEANETTE ZIEGLER, KENOSHA, WI (US); KENNETH PATTERSON, LAKE ZURICH, IL (US); STEVE A. SCHROEDER, BELVIDERE, IL (US)

Correspondence Address: JEFFREY M. HOSTER, c/o THE NUTRASWEET COMPANY, 10 S. WACKER DRIVE, SUITE 3200, CHICAGO, IL, 60606, US

(21) Appl. No.: 09/465,402

(22) Filed: Dec. 17, 1999

Related U.S. Application Data
(60) Provisional application No. 60/112,915, filed on Dec. 18, 1998.

(51) Int. Cl. A23G 3/30

(52) U.S. Cl. 426/3

(57) ABSTRACT

The use of N-[N-(3,3-dimethylbutyl)-L-α-aspartyl]-L-phenylalanine 1-methyl ester (neotame) as a sweetener in chewing gum compositions is disclosed. The chewing gums have been found to have a clean sweet taste profile with an extremely low level of sweetener usage. The use of neotame as a sweetener in chewing gum compositions also provides an extension of both sweetness and flavor as compared to that expected from the use of other sweetener ingredients.

This application claims the benefit of U.S. Provisional Patent Application No. 60/112,915, filed Dec. 18, 1998.

### BACKGROUND OF THE INVENTION

1. Field of the Invention

The present invention relates to the use of N-[N-(3,3-dimethylbutyl)-L-α-aspartyl]-L-phenylalanine 1-methyl ester (neotame) as a sweetener in chewing gum. The use of neotame as a sweetener in chewing gum results in prolonged sweetness and flavor and low concentration of sweetener, as compared to the use of other high-intensity sweeteners.

2. Related Background Art

Chewing gums comprise many different ingredients including both natural and high-intensity sweeteners. Advantages of using high-intensity sweeteners in chewing gum include flexibility of sweetness taste delivery and economics. Among high-intensity sweeteners, aspartame has been the most widely used in chewing gum formulations. U.S. Pat. Nos. 3,943,258, 3,982,023, 4,036,992, 4,064,274, 4,122,195, 4,139,639,4,158,068, 4,246,286, 4,248,894, 4,252,830, 4,317,837, 4,357,354, 4,374,858, 4,382,963, 4,384,004, 4,556,565, 4,612,195, 4,673,577, 4,704,288, 4,711,784, 4,722,844, 4,722,845, 4,738,854, 4,741,910, 4,774,094, 4,800,095, 4,816,265, 4,822,621, 4,822,622, 4,828,845, 4,929,447, 5,064,658, 5,110,608, 5,126,151, 5,139,797, 5,167,972, 5,175,009, 5,192,561, 5,221,543, 5,296,244, 5,334,397, 5,399,365, 5,425,961, 5,431,929, 5,458,892, 5,466,471, 5,470,566, 5,510,123, 5,536,510, 5,612,070, WO 96/20608, WO 98/03076, EP 196640, JP 60-102147, JP 58-198250, JP 58-19034, and EP 27024 all relate to the use of aspartame in chewing gum. Other high-intensity sweeteners that have been used include acesulfame-K, cyclamates, saccharin, and sucralose. Blends of these sweeteners have also been used in chewing gums in attempts to achieve overall improvements of sweetness properties.

One problematic aspect of using high-intensity sweeteners in chewing gum is the rapid release of the sweetener relative to the length of time consumers prefer to chew the gum. More specifically, each high-intensity sweetener is associated with its own inherent sweetness release characteristic. It is possible to compensate for this by using high levels of sweeteners; in this way, sweetness is perceived by the consumer to last longer because more sweetener is present while chewing. However, the use of sweeteners in this fashion may result in a chewing gum which has too high of an initial sweetening impact or may result in adverse taste effects such as bitterness or other off-notes. The use of high levels of high-intensity sweeteners may also require processing and formulation changes which relate to higher cost concerns. Thus, the ability to extend the sweetness of a chewing gum composition without compromising sweetness delivery and economics is still a sought-after goal of chewing gum manufacturers.

There have been many attempts to extend the sweetness delivery in chewing gum compositions using controlled release methods. In most cases, the sweetener is “bound” to other ingredients and are then released to the palate in a more controlled fashion while chewing. For example, WO 96/20608 describes the use of a multiple encapsulation method wherein aspartame and acesulfame-K are first entrapped on a coating by absorption or agglomeration. U.S. Pat. No. 4,997,659 teaches alitame encapsulation processes for the purpose of delayed release. WO 99/13870 describes a method for producing chewing gum containing acyclic carboxamides applicable to sweeteners and flavors in order to produce a modified release when the gum is chewed. Although these methods provide improvement in the extension of sweetness while the gum is chewed, the controlled release results from either the addition of encapsulated ingredients or modification of gum components. A chewing gum composition where no encapsulation or modification is required for extending the sweetness would be highly desirable to both the consumer and the chewing gum manufacturer.

Another aspect which consumers find undesirable in chewing gum compositions is the rapid release of flavor while the gum is being chewed. Generally, flavors are released from the chewing gum at a slower rate compared to that of the sweeteners due to the difference in the flavor's solubility between the gum base and saliva. Many attempts to extend the flavor of chewing gum have been made using encapsulation, agglomeration, and/or absorption methods. For example, U.S. Pat. No. 5,217,735 describes using modified cellulose to absorb flavor ingredients and then incorporating the cellulose into chewing gum. U.S. Pat. No. 5,156,866 describes flavor component particles coated with sterol. The use of particles and resins where flavor ingredients are either agglomerated or absorbed are taught in U.S. Pat. No. 5,116,627, EP 320522 and WO 91/01132. Though these methods offer some improvement, increased flavor extension without the use of modifying methods is still desired by chewing gum manufacturers and the consumer.

Yet another problem with chewing gum compositions which comprise dipeptide sweeteners is shelf-life stability. Attempts to increase the shelf-life stability of aspartame and alitame in chewing gum compositions have been made since the introduction of these sweeteners. Presumably interactions between aspartame and alitame with other chewing gum components take place over time, rendering both aspartame and alitame susceptible to degradation. A number of references describe materials and methods of encapsulation for this purpose. For example, WO 96/20608 describes an encapsulation method to enhance the stability of aspartame in chewing gum when used in a sweetener blend with acesulfame-K; WO 95/17828 teaches the use of beta-glucans; U.S. Pat. No. 5,277,919 describes the use of benzaldehyde acetals; and U.S. Pat. No. 4,822,621 describes the use of organic acids. In each case, protection methods are described which provide improvement of the shelf-life stability of either aspartame or alitame. While some improvement of shelf-life stability has resulted, it is still desirable to use various encapsulation materials and methods in ways which offer even greater shelf-life stability.

### SUMMARY OF THE INVENTION

This invention is directed to chewing gum compositions sweetened with neotame.

The invention also relates to methods of sweetening a chewing gum composition with neotame.

In a preferred embodiment of the present invention, the neotame is encapsulated before incorporation in a chewing gum composition.

### BRIEF DESCRIPTION OF THE DRAWINGS

FIG. 1 is a plot of the sweetness intensity of chewing gum prepared with sugar (sucrose), saccharin, aspartame, acesulfame-K, sucralose or neotame as a function of chewing time. Each chewing gum comprises the corresponding sweetener at a sweetener concentration that provides an identical (“isosweet”) degree of sweetness. The sweetness intensity was measured by a trained panel of experts and is expressed as the amount of sweetness based on a sweetness intensity scale of 0-15 units.

FIG. 2 is a plot of peppermint flavor intensity verses chewing time of chewing gums prepared with isosweet levels of aspartame (3000 ppm) and neotame (100 ppm). The chewing gum prepared with aspartame comprised a 1.5 wt % peppermint flavor, while the four neotame chewing gums comprised peppermint flavor at concentrations of 1.5, 1.25, 1.00, and 0.75 wt %. The peppermint flavor intensity was measured by a trained panel of experts and is plotted as a function of chewing time. The peppermint flavor intensity is expressed as the amount of peppermint flavor based on a universal peppermint intensity scale of 0-15 units.

FIG. 3 is a plot of both sweetness and flavor intensity of chewing gums prepared with isosweet amounts of aspartame (3000 ppm) and neotame (100 ppm), each comprising 1.5% peppermint flavor. The sweetness and peppermint flavor were measured by a trained panel of experts and are expressed as the amount of sweetness and peppermint flavor based on corresponding intensity scales of 0-15 units.

FIG. 4 is a plot of sweetness intensity verses chewing time of chewing gums prepared with neotame and comprising different flavor concentrations of 1.5, 1.25, 1.00, and 0.75 wt %. The sweetness intensity was measured by a trained panel of experts and is plotted as a function of chewing time. The sweetness intensity is expressed as the amount of sweetness based on a universal sweetness intensity scale of 0-15 units.

### DETAILED DESCRIPTION

According to the present invention, N-[N-(3,3-dimethylbutyl)-L-α-aspartyl]-L-phenylalanine 1-methyl ester (neotame), a high potency dipeptide sweetener (about 8000× sweeter than sucrose) that has the formula

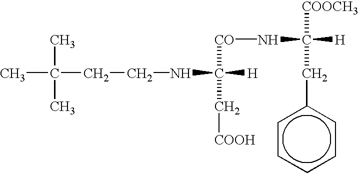

is used as a sweetener in chewing gum. It has been found that neotame delivers an acceptable level of sweetness in chewing gum and, in fact, prolongs sweetness and flavor, compared to any other sweetener. Additionally, because neotame is a high potency sweetener, it may be used at extremely low levels without sacrificing effectiveness.

Thus, one embodiment of the present invention is directed to a sweetened chewing gum composition, containing an effective amount of neotame to sweeten the chewing gum.

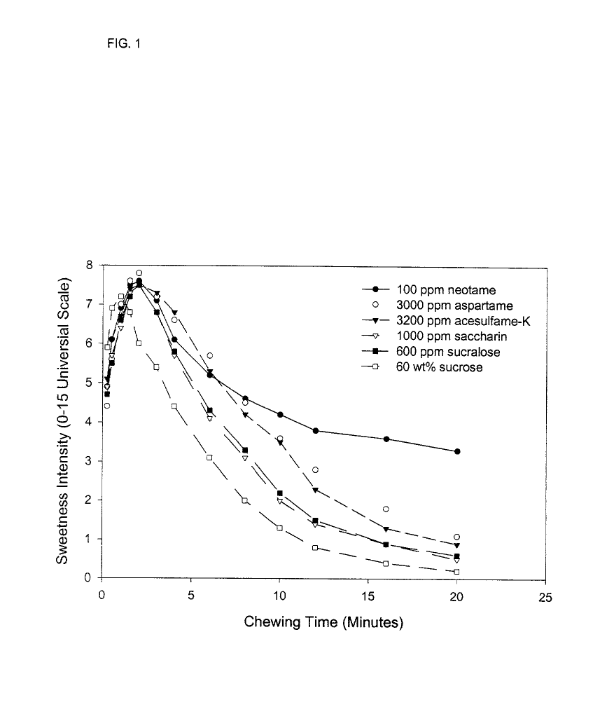

The sweetness profile of neotame in chewing gum is illustrated in FIG. 1. Also illustrated in FIG. 1 is a comparison of the sweetness intensity profiles, as measured by a trained panel of experts, of chewing gums prepared with neotame, aspartame, acesulfame-K, saccharin, sucralose, and sugar (sucrose). The sweetness detected is expressed as the amount of sweetness based on a universal sweetness scale of 0-15, and the values were obtained by having subjects of the trained panel chew pieces of gum containing the sweetener and reporting perceived sweetness after various chewing intervals. Since each chewing gum was prepared with an “isosweet” concentration (i.e., same level of sweetness; e.g., 100 ppm neotame and 3000 ppm aspartame are isosweet concentrations) of the respective sweetener and the scale is a measure of absolute sweetness at any point during chewing, the different sweetener profiles can be compared directly to each other.

The evaluation shows that the initial rate of sweetness detection that takes place between the start of chewing and 2 minutes is greater for the chewing gum comprising sucrose than the chewing gums comprising the other sweeteners. The maximum intensity perceived for a chewing gum comprising sucrose is around 1 minute's time, whereas all of the high-intensity sweeteners have a maximum sweetness intensity at around two minutes' time, all nearly identical to each other, but clearly distinct from the sweetness intensity maximum of sucrose.

Further evaluation of the plot clearly demonstrates the sweetness extension provided by neotame, in particular, that which occurs after around six minutes of chewing time, where neotame has been found to have a flatter or more uniform sweetness intensity throughout the remaining chewing time of 20 minutes. The sweetness extension provided by neotame relative to the other sweeteners can also be illustrated by comparing the actual amount of sweetness intensity loss which occurs over a specific time period of chewing.

Table 1 summarizes the sweetness intensity loss rates and average sweetness intensities which occur at a chewing time period of between 6 and 10 minutes and those which occur at a chewing time period between 10 and 20 minutes for a variety of sweeteners. The sweetness intensity loss rate is calculated as the difference in sweetness intensities measured at any two time points divided by the number of minutes of the time interval, and approximates the mathematical slope of the downward trend of sweetness intensity over time.

TABLE 1
Average sweetness loss rates and average
sweetness intensities.

| | | | average | average |
|---|---|---|---|---|
| | average | average | sweetness | sweetness |
| | sweetness | sweetness | loss rate at | intensity at |
| | loss rate at | intensity at | 10-20 | 10-20 |
| | 6-10 minutes | 6-10 minutes | minutes | minutes |
| | (intensity | (intensity | (intensity | (intensity |
| sweetener | units/min) | units) | units/min) | units) |
| neotame | 0.25 | 4.7 | 0.09 | 3.7 |
| (100 ppm) | | | | |
| aspartame | 0.52 | 4.6 | 0.25 | 2.3 |
| (3000 ppm) | | | | |
| acesulfame-K | 0.45 | 4.3 | 0.26 | 2.0 |
| (3200 ppm) | | | | |
| saccharin | 0.52 | 3.1 | 0.15 | 1.2 |
| (1000 ppm) | | | | |
| sucralose | 0.52 | 3.3 | 0.16 | 1.3 |
| (600 ppm) | | | | |
| sucrose | 0.45 | 2.1 | 0.11 | 0.6 |
| (60%) | | | | |

For example, between 6 and 10 minutes of chewing, the sweetness intensity loss rate of neotame is determined to be 0.25 sweetness intensity units per minute (i.e. (5.2−4.2 sweetness intensity units)/4 minutes=0.25). A lower sweetness loss rate corresponds directly to a greater sweetness extension. The results shown in Table 1 indicate that the sweetness loss rate of neotame is nearly half that of the sweetness loss rate of the other sweeteners evaluated within the time period of between 6 and 10 minutes. Similarly, for the time period of chewing between 10 and 20 minutes, the sweetness intensity loss rate of neotame is 0.09 sweetness intensity units per minute, where again the value for neotame is significantly less than that of the other sweeteners evaluated.

While Table 1 describes the average sweetness loss rate for a chewing gum composition having 100 ppm neotame, it is expected that similar average sweetness loss rates attributed to neotame would be exhibited in all chewing gum compositions containing neotame, regardless of the actual concentration of neotame.

It should be noted that the sweetness intensity provided by sucrose falls off so rapidly once the sweetness intensity maximum is reached (around 1 minute) that very little sweetness intensity is detected by the panel at the later chewing times. For this reason, it is important to realize that the rate of sweetness loss is only one aspect of demonstrating the sweetness extension advantage of neotame, as the rate of sweetness intensity loss should be viewed relative to the actual sweetness intensity achieved within a specific time period of chewing.

Thus, Table 1 also shows the average sweetness intensity achieved within the said time periods for each chewing gum. These values were determined by calculating the average sweetness intensity measured at the specified evaluation times. For example, for the chewing gum comprising neotame at between 6 and 10 minutes, the average sweetness intensity is determined to be (5.2+4.6+4.2)/3=4.7.

Comparison of the average sweetness intensities presented in Table 1 shows that neotame maintains a higher sweetness intensity while undergoing sweetness loss during the specified chewing time period. The comparison of the different chewing gums clearly shows that neotame provides sweetness extension by its advantageous slower rate of sweetness loss and by its ability to maintain a higher sweetness intensity throughout the duration of chewing.

It should be noted that Table 1 describes the average sweetness intensity for a chewing gum composition having 100 ppm neotame. It is expected that a proportionally higher or lower sweetness intensity would be maintained in chewing gums having proportionally higher or lower concentrations of neotame.

From this evaluation, the sweetness extension provided by neotame is such that between the time duration of about 6 to about 10 minutes of chewing, the average sweetness loss rate is less than about 0.3 sweetness intensity units per minute and an average sweetness intensity of about 4 sweetness intensity units or greater is maintained. Furthermore, at between the time duration of about 10 to about 20 minutes of chewing, the average sweetness loss rate is less than about 0.15 sweetness intensity units per minute and an average sweetness intensity of about 3 sweetness intensity units or greater is maintained.

The advantage of sweetness extension provided by neotame can also be illustrated by comparison of the sweetness intensity half-lives over time. Table 2 summarizes the half-lives of sweetness intensity of chewing gums comprising different sweeteners after the maximum sweetness intensities (around two minutes) are reached. The half-life is a measure of the time of chewing in which half of the sweetness is lost relative to the time in which the sweetness intensity maximum is achieved.

TABLE 2
Half-lives of sweetness intensity.

| | half-life |
|---|---|
| sweetener | (minutes) |
| neotame | 14.9 |
| (100 ppm) | |
| aspartame | 6.4 |
| (3000 ppm) | |
| acesulfame-K | 5.5 |
| (3200 ppm) | |
| saccharin | 4.5 |
| (1000 ppm) | |
| sucralose | 4.5 |
| (600 ppm) | |
| sucrose | 3.5 |
| (60%) | |

For example, the chewing time in which neotame lost half of its sweetness was 14.9 minutes. The chewing time in which half of the sweetness was lost in chewing gums comprising other sweeteners was significantly less and not greater than 6.4 minutes.

The amount of sweetening ingredients including neotame in the appropriate proportions can be readily formulated to provide a desired sweetness level, as well as a desired amount of sweetness extension. For example, at a sweetness intensity less than about 2 intensity units, it is believed that sweetness is not perceived by most consumers of chewing gum. Preferably, sweetness is best perceived above a sweetness intensity of about 2-3. However, those skilled in the art will understand that the degree of sweetness perception varies greatly depending upon the individual consumer.

As previously mentioned, FIG. 1 shows that chewing gums comprising each of the high-intensity sweeteners have the same sweetness intensity maximum at around two minutes, followed by the characteristic loss of sweetness intensity over time. Chewing gum comprising sucrose, however, has a sweetness intensity maximum at around one minute, followed by a sweetness intensity loss rate similar to high-intensity sweeteners other than neotame. Due to neotame's sweetness extension properties, it is now possible to incorporate a blend of neotame and a sweetener having a more rapid sweetness impact in the chewing gum composition to provide a sweetness which has both an immediate sweet impact and extended sweetness. The use of neotame in this manner offers greater flexibility and provides a method of optimizing the overall sweet taste profile of chewing gum compositions.

Rapid release sweeteners contemplated by the present invention include, but are not limited to, sucrose, mannitol, high fructose corn syrup, sorbitol, dextrose, corn syrup solids, hydrogenated starch hydrolysates, invert sugar (both liquid and dried forms), fructose, xylitol, and combinations thereof. Rapid release sweeteners that have a sweetness intensity maximum in a chewing gum composition within the first two minutes of chewing are preferred. Those skilled in the art will understand that these sweeteners may also be present in the chewing gum to provide bulk and other functionality.

According to the present invention, a chewing gum can now be prepared to provide not only an immediate and extended sweetness, but a better balance of both sweetness and flavor over an extended chewing period, a type of chewing gum heretofore unknown.

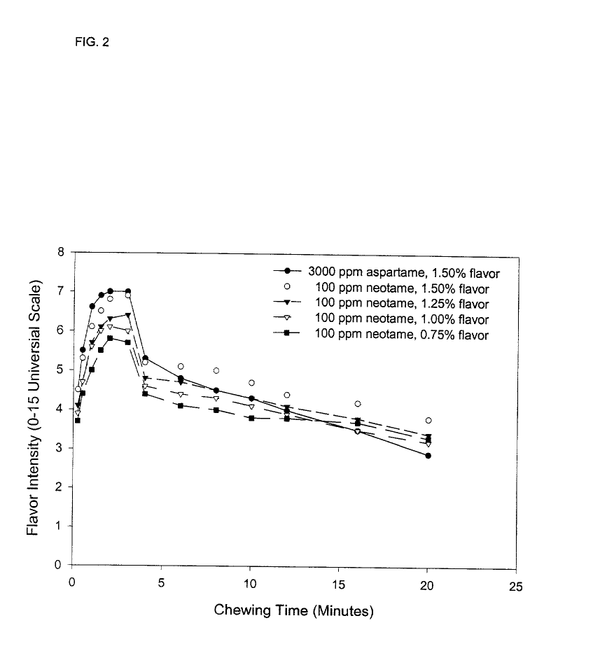

In that regard, neotame possesses exceptional flavor extension characteristics in chewing gum. FIG. 2 illustrates these flavor extension properties where the peppermint flavor intensities of chewing gums prepared with isosweet amounts of aspartame and neotame are plotted as a function of chewing time, as measured by a trained panel of experts.

According to FIG. 2, the rate of flavor loss of the chewing gum comprising neotame having 1.5% peppermint flavor is significantly less than that of the chewing gum comprising aspartame having the same amount of flavor, measured after the flavor intensity maximum has been reached (around 4 minutes). As in the case of sweetness intensity comparisons, since the chewing gums were prepared with an identical amount of flavor and the scale is a measure of absolute flavor at any point during chewing, the different flavor profiles can be compared directly to each other. The rate of flavor intensity loss of the chewing gum comprising neotame is 0.0875 flavor intensity units per minute, while that of chewing gum comprising aspartame was determined to be 0.150 flavor intensity units per minute. Thus, the rate of flavor loss of a chewing gum comprising neotame is nearly half that of the flavor loss for a chewing gum comprising aspartame at an isosweet level and containing an equal concentration of peppermint flavor.

It was also discovered that chewing gums comprising neotame containing lesser amounts of peppermint flavor (i.e. 0.75%, 1.00%, and 1.25%) result in a flavor intensity loss over time that is non-linear. Since the rate of flavor intensity loss is not linear over the duration of the chewing time with respect to the actual flavor concentration used in the chewing gums, the chewing gums comprising neotame with lesser amounts of peppermint flavor show the advantage of providing a reduced flavor intensity rate loss while maintaining a greater flavor intensity. This advantage provided by neotame in chewing gum can clearly be seen from the summary of flavor intensity loss rates as shown in Table 3.

TABLE 3
Summary of peppermint flavor loss rates at
corresponding average peppermint flavor intensities for
the chewing time period of between 4 and 20 minutes, as
measured by a trained panel of experts.

| | | flavor | average |
|---|---|---|---|
| | % | loss rate | flavor |
| | peppermint | at 4-20 | intensity at |
| sweetener | flavor | minutes | 4-20 minutes |
| aspartame | 1.50 | 0.150 | 4.2 |
| (3000 ppm) | | | |
| neotame | 1.50 | 0.088 | 4.6 |
| (100 ppm) | | | |
| neotame | 1.25 | 0.088 | 4.2 |
| (100 ppm) | | | |
| neotame | 1.00 | 0.075 | 4.0 |
| (100 ppm) | | | |
| neotame | 0.75 | 0.070 | 3.9 |
| (100 ppm) | | | |

Compared to that of chewing gums comprising aspartame having 1.5% flavor, the chewing gums comprising neotame at each flavor amount all have significantly reduced flavor intensity loss rates. The average flavor intensities of the chewing time period between 4 and 20 minutes are shown. For a chewing gum comprising neotame having 1.5% flavor, the flavor intensity rate loss while maintaining a greater flavor intensity is clearly advantageous compared to chewing gums comprising aspartame having the same flavor amount. Furthermore, for the chewing gums comprising neotame having less flavor amounts, the average flavor intensities are all around 4.0 intensity units, demonstrating both the flavor extension and flavor “sparing” properties of neotame.

The flavor sparing property of neotame allows for chewing gum compositions in which less flavor amounts are used to achieve a flavor intensity profile typically expected from a full-flavored chewing gum (i.e., chewing gums containing the typical or non-reduced amount of flavor). In this way, the overall cost of the chewing gum manufacture is lowered. These unique flavor extension and flavor sparing properties of chewing gums comprising neotame provide advantages in chewing gum heretofore unknown.

Based on the newly discovered flavor extension and flavor sparing properties of neotame in chewing gum, between the time duration of about 4 minutes to about 20 minutes of chewing, the flavor extension provided by neotame in a full-flavored chewing gum is such that the average flavor loss rate is less than about 0.1 flavor intensity units per minute and an average flavor intensity of about 4 flavor intensity units or greater is maintained. For chewing gums comprising neotame containing flavor amounts less than that required for a full-flavored chewing gum, the amount of flavor can be reduced from that used in a full-flavored chewing gum to at least around 50%, while providing an average flavor loss rate of less than about 0.1 flavor intensity units per minute and maintaining an average flavor intensity of about 3.5 flavor intensity units or greater.

One problematic aspect of typical chewing gums is that the intensities of both sweetness and flavor are not comparable throughout the chewing duration. The intensity of both sweetness and flavor perceived by consumers should be both comparable and compatible at any time point of chewing. Perceived sweetness without accompaniment of flavor or perceived flavor without the accompaniment of sweetness is undesirable to the consumer.

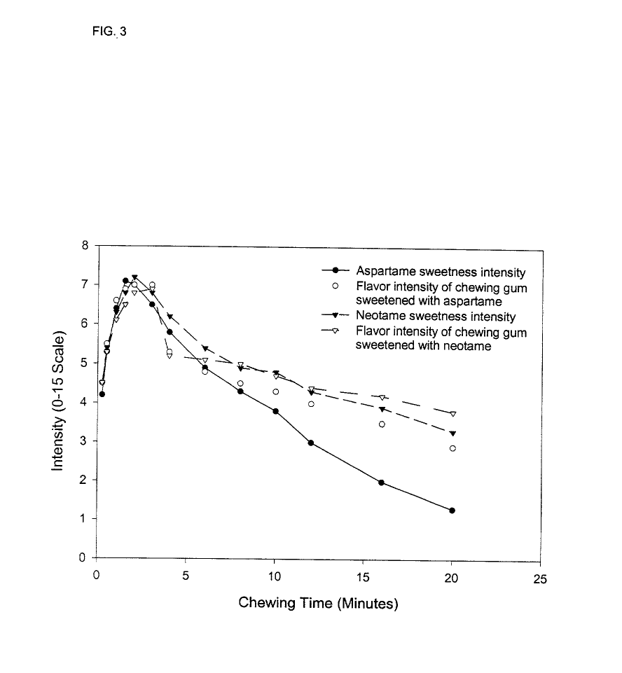

Chewing gums comprising neotame provide the advantage of maintaining a better balance between sweetness and flavor compared to chewing gums comprising other sweeteners. FIG. 3 illustrates this property by comparing the sweetness and flavor profiles of chewing gum comprised of isosweet amounts of neotame and aspartame, each having identical peppermint flavor amounts of 1.5%. Because of aspartame's relatively high sweetness intensity loss rate that occurs between 6 and 20 minutes compared to the loss rate of flavor intensity, the balance of sweetness intensity and flavor intensity is not maintained, as reflected by the differences of sweetness and flavor intensities at chewing times greater than around 6 minutes.

However, in chewing gums comprising neotame, the rates of sweetness and flavor loss during chewing are more similar, and as a result the chewing gum provides a greater balance of sweetness and flavor intensities. Based on this discovery, a chewing gum comprising neotame can be prepared wherein the difference between sweetness intensity and flavor intensity is at least less than around 1 universal intensity units during the chewing time period of between around 6 minutes and around 20 minutes. The balance of sweetener extension and flavor extension is comparably maintained throughout the duration of chewing.

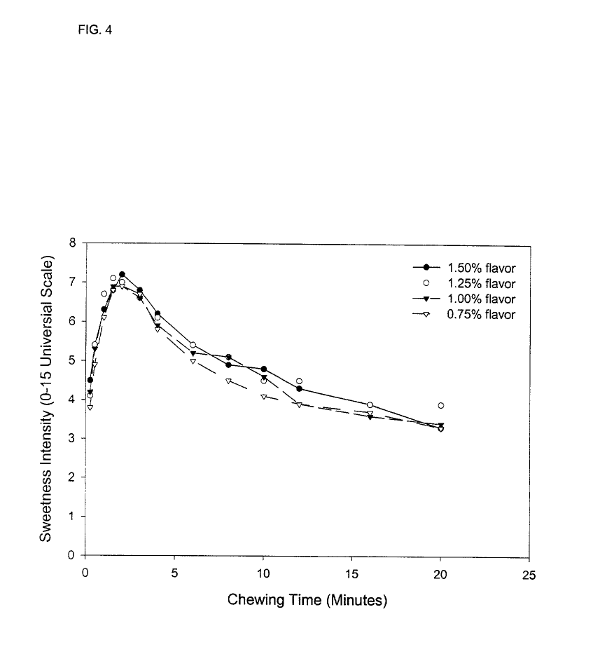

A chewing gum comprising a sweetener which provides a useful level of sweetness intensity extension and allows for a significant reduction of flavor amount is also desirable. Typically, chewing gums are formulated to contain relatively large concentrations of a flavor ingredient compared to the amount of sweetness that is delivered in order to help offset the higher rate of sweetness loss while the gum is chewed. FIG. 4 illustrates the advantage provided by neotame wherein less flavor amounts are required to maintain comparable sweetness intensities and sweetness extension, in particular at extended chewing times. The measured sweetness intensities are plotted as a function of chewing time of chewing gum prepared with neotame having lesser amounts (i.e. 0.75%, 1.00%, and 1.25%) of peppermint flavor.

According to FIG, 4, the lesser amounts of peppermint flavor used do not significantly affect the sweetness intensities of neotame over the time duration of chewing, as the level of sweetness intensity of each chewing gum over the duration of the chewing time is nearly identical. Therefore, the use of neotame can provide a chewing gum composition which can contain a significantly less amount of flavor ingredient to achieve a comparable sweetness intensity that would be expected from a full-flavored chewing gum. Based on this discovery, the amount of flavor in such a gum can be reduced by at least around 50% when compared to that of a full-flavored chewing gum sweetened with sucrose or another high-intensity sweetener.

Table 4 summarizes the half-lives of both sweetness and flavor of chewing gums prepared with aspartame (3000 ppm) with 1.5 wt % flavor and neotame (100 ppm) with 1.5, 1.25, 1.00, and 0.75 wt % flavor amounts. The half-life is the time in minutes for the intensity to fall to half of its maximum value (sweetness, 2 minutes; flavor, 4 minutes).

TABLE 4
Summary of the half-lives of sweetness
intensity and peppermint flavor intensity.

| sweetener | sweetness | peppermint |
|---|---|---|
| aspartame | 7.6 | 19.7 |
| (1.50% flavor) | | |
| neotame | 17.0 | 44.3 |
| (1.50% flavor) | | |
| neotame | 17.2 | 31.3 |
| (1.25% flavor) | | |
| neotame | 20.7 | 31.7 |
| (1.00% flavor) | | |
| neotame | 16.9 | 33.1 |
| (0.75% flavor) | | |

Comparing the chewing gums prepared with aspartame and neotame at the 1.5% flavor concentration clearly shows the advantage of both sweetness and flavor extension provided by neotame. The sweetness extension which occurs in chewing gums containing neotame with reduced flavor amounts is also shown to be advantageous, as the half-lives are all comparable to that measured for the chewing gum containing 1.5% flavor. The flavor extension properties that neotame provides are also shown by comparing the half-lives of flavor provided by the lesser flavor amounts to that provided by aspartame.

The chewing gum comprising neotame of the present invention, when chewed, releases its ingredients in a manner which yields a desirable balance of sweetness and flavor throughout the chewing period disclosed. The chewing gum comprising neotame of the present invention has a more overall intense sweetness and flavor at longer chewing times than heretofore known compared to other sweeteners and maintains its sweetness and flavor throughout the aforementioned chewing period.

When used in chewing gum compositions, neotame possesses unique sweetness and flavor extension characteristics, as well as advantageous flavor sparing and sweetness and flavor balancing properties, most likely due to neotame's unique functionality in a given chewing gum composition. Neotame's surprising properties are likely due to favorable interactions with the gum base components. Also, since neotame displays a relatively high solubility in non-aqueous solvents compared to other high-intensity and natural sweeteners, it might be expected that neotame would remain in the gum base phase, rather than quickly dissipate in the saliva phase as demonstrated by other sweeteners during chewing. However, neotame does provide a significant sweetness impact during the initial chewing period in addition to maintaining a sustained sweetness intensity throughout the duration of chewing. The functionality of neotame in chewing gum is likely linked to both its solubility behavior as well as its affinity properties with the chewing gum components.

The neotame suitable for use in the present invention may be prepared through a variety of methods. The chemical synthesis of neotame is disclosed in U.S. Pat. Nos. 5,480,668, 5,510,508, and 5,728,862, the disclosure of each of which is incorporated by reference herein. Salts and complexes of neotame, as well as blends of neotame with other high intensity and natural sweeteners, are also suitable for use in the present invention.

The neotame used in chewing gum compositions may take any form. For example, it may be a salt or complex such as described in U.S. patent application Ser. No. 09/146,963, U.S. patent application Ser. No. 09/146,964, U.S. patent application Ser. No. 09/148,134, U.S. patent application Ser. No. 09/146,965, all filed Sep. 4, 1998, the disclosure of each of which is incorporated by reference herein. Other exemplary forms of neotame that may be used in this invention include co-crystallized forms and cyclodextrin complexes, such as described in U.S. patent application Ser. No. 09/154,568 and U.S. Provisional Patent Application No. 60/100,867, both filed Sep. 17, 1998, the disclosures of each of which are incorporated by reference herein. Agglomerates and other processed forms of neotame, including granulated neotame as described in U.S. Provisional Patent Application No. 60/126,363, filed Mar. 26, 1999, the disclosure of which is incorporated by reference herein, and various crystallized forms of neotame using different processes may also be used.

The amount of neotame can be readily formulated to provide a desired sweetness level in chewing gum compositions. Neotame is able to provide an acceptable sweetness in chewing gum when used as the sole sweetening ingredient or when used as part of a sweetener blend. If neotame is replacing all of the sweetness conventionally found in a chewing gum, the amount will range from about 10 ppm to about 1600 ppm. More preferably, the amount of neotame will range from about 40 ppm to about 600 ppm. Most preferably, this range is from about 100 ppm to about 250 ppm.

In other words, neotame is present in a final chewing gum composition of the present invention in an amount of from about 0.001% to about 0.16% by weight, preferably in an amount of from about 0.004% to about 0.06% by weight, and most preferably in an amount of from about 0.01% to about 0.025% by weight of the composition. Of course, lesser amounts my be employed when other sweeteners are present.

A further embodiment of the present invention is directed to a chewing gum comprising a gum base, an effective amount of neotame, and any other essential chewing gum ingredient.

The chewing gum composition sweetened with neotame can include any known chewing gum ingredient. These include, without limitation, other sweeteners, gum base, texturizers, humectants, crystallization inhibitors, bulking agents, emulsifiers, plasticizers, acids, colors, anti-oxidants, and flavors. It is recognized that many of these ingredients and those described herein inherently provide more than one functionality.

Other sweeteners that may be employed in the neotame sweetened chewing gum compositions of the present invention include known natural sweeteners as well as high-intensity sweeteners. Natural sweeteners include saccharide containing components commonly known in the chewing gum art which comprise, but are not limited to sucrose (sugar), glucose (dextrose), xylose, ribulose, maltose, dextrin, dried invert sugar, fructose (levulose), mannose, galactose, corn syrup solids, alone or in any combination. Other sugar related substances include maltodextrins, isomalt, partially hydrolyzed starch, hydrogenated starch hydrolysates, hydrogenated hexoses, hydrogenated disaccharides, and mixtures thereof Sugarless sweeteners include components with sweetening characteristics but are devoid of the commonly known sugars and comprise, but are not limited to, sugar alcohols such as sorbitol, mannitol, xylitol, galactitol, hydrogenated starch hydrolysates, maltitol, and the like, alone or in any combination. Use of any of these sweeteners in chewing gum compositions would naturally reduce the level of neotame required for a particular application.

Also contemplated for use in the chewing gum compositions of the present invention is any other high-intensity sweetener. Examples of suitable high-intensity sweeteners include (A) water-soluble naturally-occurring intense sweeteners such as dihydroxychalcones, monellin, steviosides, glycyrrhizins, dihydroflavenol, and L-aminodicarboxylic acids, aminoalkenoic acid ester amides, such as those disclosed in U.S. Pat. No. 4,619,834, the disclosure of which is incorporated by reference herein, and mixtures thereof; (B) water-soluble artificial sweeteners including the soluble saccharin salts of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (acesulfame-K), the free acid form of saccharin, and the like, and mixtures thereof; (C) dipeptide based sweeteners including aspartame, other L-aspartic acid derivatives described in U.S. Pat. No. 3,492,131, the disclosure of which is incorporated by reference herein, L-alpha-aspartyl-N-(2,2,4,4-tetramethyl-3-thietanyl)-D-alaninamide hydrate (alitame), methyl esters of L-aspartyl-L-phenyl-glycerine and L-aspartyl-L-2,5-dihydrophenyl-glycine, L-aspartyl-2,5-dihydro-L-phenylalanine, L-aspartyl-L-(1-cyclohexene)-alanine, and the like, and mixtures thereof; (D) water-soluble intense sweeteners derived from naturally occurring water-soluble sweeteners, such as chlorinated derivatives of ordinary sugar (sucrose), e.g., chlorodeoxysugar derivatives and mixtures thereof, and (E) protein based intense sweeteners such as thaumacoccous danielli (thaumatin I and II). Again, use of these sweeteners in chewing gum compositions would naturally reduce the level of neotame required for a particular application.

These other natural and high intensity sweeteners may be employed in the chewing gum compositions of the present invention as separate ingredients added at some point in the processing or as part of a blend with neotame. Those skilled in the art will recognize that any combination of natural and high intensity sweeteners may be employed in the chewing gum. Further, those skilled in the art will recognize the sweetener may also function in the chewing gum in whole or in part as a water soluble bulking agent or softener. In addition, a softener may be combined with the sweetener such as in an aqueous sweetener solution. In one preferred embodiment of the present invention, a blend of neotame and xylitol is used to sweeten a chewing gum composition. When used in a blend with another sweetener, the neotame is generally present in an amount of from about 0.1 ppm to about 1200 ppm.

In general, a chewing gum composition comprises a water soluble bulk portion and a water insoluble chewable gum base portion, each of which are comprised of specific ingredients which make up the chewing gum composition. The water soluble portion dissipates with a portion of the sweetener and flavoring agent over a period of time during chewing. The gum base portion is retained in the mouth throughout the chew. As can be appreciated by one of ordinary skill in this art, any of the materials listed at 37 C.F.R. §172.615 may be incorporated into the chewing gum compositions of the present invention.

The insoluble gum base generally comprises resins, fats and oils, waxes, elastomers, softeners and inorganic fillers. Resins generally include polyvinyl acetate and terpene resins. Fats and oils generally include animal fats such as lard and tallow, vegetable oils such as soybean and cottonseed oils, hydrogenated and partially hydrogenated vegetable oils, and cocoa butter. Commonly used waxes include petroleum waxes such as paraffin, and natural waxes such as candellia, carnuba, beeswax, and polyethylene. Preferably, the waxes have a melting point between 90° F. and 230° F. Elastomers may include polyisobutylene, isobutylene-isoprene copolymer and styrene butadiene rubber, as well as natural latexes such as chicle.

The insoluble gum base portion typically also includes a filler component such as calcium carbonate, magnesium carbonate, talc, dicalcium phosphate, or combinations thereof. The insoluble gum base also generally is comprised of a softener ingredient such as glycerol monostearate, glycerol triacetate, and combinations thereof. Optional ingredients generally include antioxidants, colors, emulsifiers, and ingredients which provide hygienic functionalities.

The water soluble portion of the chewing gum composition may further comprise softeners, sweeteners, flavoring agents and combinations thereof. Softeners are added to the chewing gum in order to optimize the chewability and mouthfeel of the gum. Softeners, also known in the art as plasticizers or plasticizing agents, generally constitute between about 0.5 to about 15.0 weight percent of the chewing gum. Softeners contemplated by the present invention include glycerin, lecithin, and combinations thereof. Further, aqueous sweetener solutions such as those containing sorbitol, hydrogenated starch hydrolysates, corn syrup and combinations thereof may be used as softeners and binding agents in gum.

Texturizers suitable for use in the present invention include, without limitation, lycasin, glycerin, mannitol, and combinations thereof.

Humectants suitable for use in the present invention include, without limitation, glycerin, sorbitol, and combinations thereof.

Crystallization inhibitors suitable for use in the present invention include, without limitation, mannitol.

Bulking or binding agents suitable for use in the present invention include, without limitation, dextrose, maltodextrin, lactose, inulin, cellulose, cellulose derivatives, gelatin, xanthan, guar, pectins, locust bean, alginates, agar, carrageenans, gum acacia, tara gum, karaya gum, gellan gum, gurcellaran, tragacanth, guar gum hydrolysate, ghatti, microcrystalline cellulose, carbomethyl-cellulose, hollocellulose, cellulose gel, polydextrose, maltodextrose, isomalulose, polymaltose, arabinogalactan, palatinose, starches, starch hydrolysates, hydrogenated starch hydrolysates, partially hydrolyzed starch, dextrins, hydrogenated hexoses, fructooligosaccharides, sorbitol, xylitol, mannitol, maltitol, galactitol, isomalt, and mixtures thereof.

Organic acids suitable for use in the present invention include, without limitation, citric acid, malic acid, tartaric acid, and mixtures thereof.

Any suitable colorant may be used in the chewing gum compositions of the present invention. There are no limitations as to the types of colorant that can be used in compositions containing neotame; therefore, any colorant recognized in the art as a traditional colorant useful for chewing gum compositions can be used.

Any suitable flavor may be used in the chewing gum compositions of the present invention. Chewing gum compositions typically contain a variety of different flavorings, and there is no limitation as to the types of flavoring ingredients which can be used in chewing gums sweetened with neotame. Flavoring ingredients are typically present in chewing gums in amounts from about 0.1 wt % to about 10 wt %, and preferably from about 0.75 wt % to about 3 wt % of the gum. The flavoring ingredient may comprise essential oils, synthetic flavors, or mixtures thereof including, but not limited to, oils derived from plants and fruits such as citrus oils, fruit essences, peppermint oil, spearmint oil, clove oil, oil of wintergreen, anise, cinnamon, and fruit flavors such as tutti frutti, strawberry, raspberry, lemon, and orange. Artificial flavoring components are also contemplated for the present invention. Those skilled in the art will recognize that natural and artificial flavoring ingredients may be combined in any blend that is deemed acceptable. All such flavors and flavor blends are contemplated by the present invention. Generally, the amounts of colorants and flavorings that are used are normally a matter of preference subject to type and desired end-strength.

Optional ingredients such as emulsifiers and pharmaceutical agents may also be added to the chewing gum, and these types of additives are also contemplated by the present invention.

In another preferred embodiment of the present invention, neotame is encapsulated or formed as an admixture with a suitable agent for use as a sweetener in chewing gum compositions. Incorporation of said encapsulated form or admixture form of neotame into chewing gum compositions extends the shelf-life stability of neotame. The encapsulated or admixture forms provide protection of neotame from chewing gum components which may interact with neotame over time. As a consequence, chewing gum compositions containing encapsulated or admixed neotame are more stable than chewing gums comprising neotame in a non-encapsulated or non-admixture form.

Suitable materials include, without limitation, cellulose and cellulose derivatives such as hydroxypropylmethyl cellulose, stearic acid, shellac, polyethylene wax 500, zein, sterine 27, alginates, gelatin, starches, proteins, sugars, sugar alcohols, complex carbohydrates, gums, hydrocolloids, gellan gum, polydextrose, polywax, hydrogenated starch hydrolyzate, polyvinyl acetate, xanthan gum, carrageenan, dextrose, malic acid, maltodextrin, gum arabic and combinations thereof. Materials preferable for use in the present invention include hydroxypropylmethyl cellulose, polyvinyl acetate and zein. In an encapsulated or admixed composition, neotame is generally present in an amount of 0.5-20% by weight of the encapsulated or admixed composition.

Furthermore, those skilled in the art will recognize that any traditional method of encapsulation or that used to form an admixture can be employed. These include, but are not limited to, methods such as spray drying, granulation, agglomeration, fluidized bed agglomeration, complex coacervation, spray chilling, prilling, extrusion, methods of drying such as drum-drying, freeze-drying, oven-drying, processing through a rotary disk, and other similar techniques.

One skilled in the art would appreciate that any encapsulation method or material useful in the encapsulation or admixing of aspartame or other high-intensity sweeteners, as well as other chewing gum ingredients, would be suitable for use in the encapsulation or admixture of neotame. Several of these methods and materials can be found in U.S. Pat. Nos. 4,139,639, 4,384,004, 4,590,075, 4,673,577, 4,711,784, 4,722,845, 4,726,953, 4,816,265, 4,824,681, 4,911,934, 4,929,447, 4,933,190, 4,952,402, 4,975,270, 4,978,537, 4,981,698, 4,986,991, 5,043,169, 5,064,658, 5,108,763, 5,126,151, 5,139,798, 5,154,939, 5,164,210, 5,167,972, 5,169,697, 5,192,561, 5,334,397, 5,338,809 and 5,532,004, WO 8911212, WO 8903170, WO 9007859, WO 9007864, WO 9103147, WO 960608, WO 9704662, WO 9803076, EP 252374, EP 427541, and GB 2225923, the disclosures of which are incorporated by reference herein.

Other ingredients may be added to provide additional functionalities which may be desired for certain applications in the same manner used with aspartame and other high-intensity sweeteners. For example, U.S. Pat. Nos. 5,217,735, 5,221,543, 4,800,095, 5,112,625, 4,885,175, 4,839,184, 4,374,858, and 5,665,406 relate to the manipulation of desired functionalities of aspartame and are incorporated by reference herein.

As mentioned above, it is possible to use neotame in combination with other natural or high-intensity sweeteners. In such embodiments of the present invention, neotame may be encapsulated or admixed, while the other sweetener(s) is not. Alternatively, either both or neither neotame and the other sweetener(s) may be encapsulated or admixed for use in chewing gum formulations.

Prior to encapsulation, neotame may be spray-dried in combination with any suitable vehicle. These vehicles include, without limitation, gum arabic, starch, and maltodextrin. Typically, these vehicles are used in approximately 20% concentration in water and neotame is generally present in an amount of 2-10% by weight of the spray-dried composition.

Those skilled in the art will recognize that various materials and methods of encapsulation will afford different degrees of protection, thereby resulting in different levels of shelf-life stability enhancement of neotame. The preferred quantity and type of encapsulating or other material employed to protect neotame from interacting with other chewing gum components may be specifically tailored depending upon a variety of factors including, but not limited to, the encapsulation or other method employed to form said admixture, the type of encapsulant or material agent used to form said admixture, and the amount of encapsulant or other material agent used to form said admixture. Since the level of protection may be governed by a number of factors such as cost, desired stability enhancement, and degree of processing conditions, it is contemplated that those skilled in the art will recognize the various factors and make adjustments as necessary in order to achieve a level of stability enhancement desired.

As part of the present invention, it is contemplated that the sweetness extension properties of neotame during the chewing period can be increased further by adding said neotame to chewing gum in a form that affords an even longer sweetness extension, such as that expected from encapsulated, co-dried, and agglomerated forms.

It is also contemplated by the present invention that chewing gum comprising neotame can be prepared by these methods to yield various controlled rates of sweetness intensity over the duration of a particular chewing time. Thus, manufacturers will be able to produce a chewing gum which may more closely approximate a constant desirable sweetness level over time. Examples of extending the sweetness in chewing gums by encapsulation or forming an admixture with another substance are well known in the art, and it is contemplated that this type of formulation can be carried out by one ordinarily skilled in the art.

It is also contemplated by the present invention that one ordinarily skilled in the art will recognize that various forms of chewing gums can be manufactured. In general, chewing gum is manufactured by sequentially adding the various chewing gum ingredients to any commercially available mixer known in the art. After the ingredients have been thoroughly mixed, the gum mass is discharged from the mixer and shaped into the desired form such as by rolling into sheets and cutting into sticks, extruding into chunks, or casting into pellets.

It is also anticipated that the physical form in which neotame exists when added to the chewing gum composition may affect its sweetness extension properties during chewing. Different physical forms contemplated include, but are not limited to, powdered, granular, extruded, compacted, or particulate forms. Chemical forms contemplated include anhydrous forms, amorphous forms, partially hydrated forms, and solvated forms. Of course, it is contemplated that the sweetness extension of these forms can further be altered by encapsulation or agglomeration methods, or co-drying to provide an admixture of neotame and another acceptable chewing gum component.

It is also contemplated that neotame may be altered in its sweetness and flavor extension properties by dissolving said neotame in a food acceptable solvent prior to being added to the chewing gum composition during formulation. Suitable solvents include, but are not limited to, ethanol, propylene glycol, glycerin, glycerol triacetate, vegetable oil, ethyl acetate, and combinations thereof. In addition, flavoring agents, because of their ability to dissolve neotame, individually or as a blend, are considered suitable solvents. The optimal solubility level of neotame in a solvent that is amenable to the manufacture of chewing gum can be readily determined.

Another embodiment of the present invention is directed to a process for sweetening a chewing gum composition by including in the chewing gum composition an effective amount of neotame. One of ordinary skill in this art would appreciate that the inclusion of neotame in a chewing gum composition can be accomplished by any means. Suitable means include adding neotame to a mixture of chewing gum ingredients, adding neotame to the surface of a chewing gum composition and then adding a protectant such as zein or a polyol, and adding a liquid dispersion of neotame in a substance such as glycerin to a piece of chewing gum.

All of the aforementioned advantages are made possible by the present invention disclosed herein. Other advantages realized from the present invention which are not mentioned but which will be readily apparent to those skilled in the art are also contemplated.

The art has not investigated sweetener extension of neotame as a function of gum base composition. The various components of the chewing gum composition are believed to have no deleterious effect on the sweetness extension properties of neotame.

It is expected that a wide range of changes and modifications to the preferred embodiments described above will be apparent to those skilled in the art. The examples which follow are intended as an illustration of certain preferred embodiments of the invention, and no limitation of the invention is implied.

### EXAMPLE 1

Chewing Gum Composition Sweetened with 0.025% Neotame

A chewing gum containing neotame was prepared in accordance with the present invention. The chewing gum was prepared by mixing powdered neotame with the other ingredients listed and in the proportions specified below by the following general procedure:

| ingredient | weight percent |
|---|---|
| sorbitol | 46.750 |
| gum base | 26.250 |
| lycasin | 14.583 |
| glycerin | 5.833 |
| mannitol | 5.100 |
| peppermint flavor | 1.458 |
| neotame | 0.025 |

An Aaron gum mixer steam jacket was first warmed to 120-140° F. The gum base was then added to the mixer and softened. Half of the sorbitol powder was then added, followed by mixing for about two minutes. The lycasin was then added, followed by additional mixing for two minutes. Glycerin was then added, and the mixture was mixed for three minutes. The remainder of the sorbitol powder and the neotame were then added, followed by mixing for two minutes. Mannitol was then added, mixed for five minutes, followed by addition of the peppermint flavor. After mixing an additional four minutes, the gum was removed from the mixer and dusted with mannitol. The gum was then rolled and pressed to form a flat sheet of approximately 0.2 inches thick, after which the gum was cut into pieces that measured approximately 1.5×0.5 inches and weighed 2.6 to 2.8 grams. The pieces of gum were individually wrapped in a laminate consisting of foil, adhesive, and tissue paper. The resulting chewing gum was tested by a panel of experts and the chewing gum exhibited both sweetness and flavor extension properties in accordance with the present invention.

### EXAMPLE 2

Chewing Gum Composition Sweetened with 0.010% Neotame

A chewing gum containing neotame was prepared in accordance with the procedure of Example 1 using the ingredients listed below.

| ingredient | weight percent |
|---|---|
| sorbitol | 46.765 |
| gum base | 26.250 |
| lycasin | 14.583 |
| glycerin | 5.833 |
| mannitol | 5.100 |
| peppermint flavor | 1.458 |
| neotame | 0.010 |

The resulting chewing gum was tested by a panel of experts, and the chewing gum exhibited both sweetness and flavor extension properties in accordance with the present invention.

### EXAMPLE 3

Formation of Gum Arabic, Starch, and Maltodextrin Admixtures of Neotame

Neotame was formed as an admixture with gum arabic, starch, and maltodextrin in accordance with the present invention by mixing neotame separately with the co-agents followed by spray-drying. Gum arabic, starch, and maltodextrin were separately prepared as 20% solutions in water. Neotame was first dissolved in ethanol, and the ethanol solution containing neotame was added to the co-agent solution. The ethanol solution containing neotame and the co-agent solution were mixed together, and the solution was then spray-dried at an outlet temperature of 130-135° F. to produce a white to off-white free-flowing powder. Chewing gums comprising each admixture form were prepared in accordance with the procedure of Example 1. The resulting chewing gums were tested by a panel of experts and the chewing gums exhibited both sweetness and flavor extension properties in accordance with the present invention.

### EXAMPLE 4

Agglomeration of Neotame with Dextrose

A neotame solution was prepared by dissolving 30 g of neotame into 100 g of water and 40 g of ethanol. The neotame solution was sprayed onto 970 g of dextrose in a fluid bed at a rate of 5 g/min, until all the solution had entered the fluid bed and was agglomerated to the dextrose. The resultant product was neotame diluted with dextrose containing 2.8 wt/wt % neotame. The particle size distribution for the product was: 1.2% 40 mesh, 5.9% 100 mesh, 24.5% 140 mesh, 58.4% 200 mesh and 10.0% greater than 200 mesh.

### EXAMPLE 5

Encapsulation of Neotame with Polyvinyl Acetate

A 15% solution of polyvinyl acetate in methanol was prepared as the spray solution for a Wurster column. Neotame (500.0 g) diluted with dextrose from Example 4 was added to the bowl of the Wurster column. When the contents of the bowl reached a temperature of 140° F., the 15% polyvinyl acetate solution was applied to the contents of the bowl. The spray rate was maintained around 5.0 g/min, until 20% polyvinyl acetate solids was added to the contents in the bowl. The product obtained was a coating of 20% polyvinyl acetate solids on the neotame diluted with dextrose (1.83% neotame). A sample of 200.0 g was collected.

Then 300.0 g of the 20% polyvinyl acetate solids product was returned to the bowl and coated in the same manner above until a 40% polyvinyl acetate solids product was obtained. A sample of 200.0 g was collected. The particle size distribution for the product was: 3.3% 40 mesh, 72.4% 100 mesh, 18.9% 140 mesh, 5.4% 200 mesh and 0.5% greater than 200 mesh.

### EXAMPLE 6

Encapsulation of Neotame with Hydroxypropylmethyl Cellulose

A 10% solution of hydroxypropylmethyl cellulose in water was prepared as the spray solution for a Wurster column. Neotame (500.0 g) diluted with dextrose from Example 4 was added to the bowl of the Wurster column.

When the contents of the bowl reached a temperature of 170° F., the 10% hydroxypropylmethyl cellulose solution was applied to the contents of the bowl. The spray rate was maintained around 5.0 g/min, until 10% hydroxypropylmethyl cellulose solids was added to the contents in the bowl. The product obtained was a coating of 10% hydroxypropylmethyl cellulose solids on the neotame diluted with dextrose. A sample of 200.0 g was collected.

Then 273.0 g of the 10% hydroxypropylmethyl cellulose solids product was returned to the bowl and coated in the same manner above until a 20% hydroxypropylmethyl cellulose solids product was obtained (2.14% neotame). A sample of 200.0 g was collected. The particle size distribution for the product was: 18.7% 40 mesh, 55.4% 100 mesh, 8.8% 140 mesh, 8.1% 200 mesh and 9.7% greater than 200 mesh.

### EXAMPLE 7

Encapsulation of Neotame with Zein

A 13.5% solution of zein in methanol/water (69% methanol/16% water/13.5% zein/1.5% myvacet) was prepared as the spray solution for a Wurster column. Neotame (500.0 g) diluted with dextrose from Example 4 was added to the bowl of the Wurster column. When the contents of the bowl reached a temperature of 165° F., the 13.5% zein solution was applied to the contents of the bowl. The spray rate was maintained around 5.0 g/min, until 10% zein solids was added to the contents in the bowl. The product obtained was a coating of 10% zein solids on the neotame diluted with dextrose. A sample of 200.0 g was collected.

Then 273.0 g of the 10% zein solids product was returned to the bowl and coated in the same manner above until a 20% zein solids product was obtained (2.33% neotame). A sample of 200.0 g was collected. The particle size distribution for the product was: 0.5% 40 mesh, 2.3% 100 mesh, 13.7% 140 mesh, 47.8% 200 mesh and 35.9% greater than 200 mesh.

### EXAMPLE 8

Encapsulation of Neotame with Capsul Starch

Capsul starch (3 kg) (National Starch & Chemical, Bridgewater, N.J.) was mixed into 7 kg water. The mixture was heated to 190° F. and held for one hour. After one hour, the mixture was cooled to 150° F. Then 36.1 g neotame was added to 4.02 kg starch solution. The resultant mixture was spray dried using a spray drier. The inlet air temperature ranged form 160° C.-330° C., and the outlet temperature ranged form 90° C.-120° C. The final product was neotame encapsulated with capsul starch (2.64 wt/wt % neotame). The particle size distribution for the product was: 0.1% 40 mesh, 0.4% 100 mesh, 0.5% 140 mesh and 99.0% greater than 200 mesh.

### EXAMPLE 9

Encapsulation of Neotame with Capsul Starch/Zein

A 13.5% solution of zein in methanol/water (69% methanol/16% water/13.5% zein/1.5% myvacet) was prepared as the spray solution for a Wurster column. Neotame (400.0 g) encapsulated with capsul starch from Example 8 was added to the bowl of the Wurster column. When the contents of the bowl reached a temperature of 165° F., the 13.5% zein solution was applied to the contents of the bowl. The spray rate was maintained around 5.0 g/min, until 10% zein solids was added to the contents in the bowl. The product obtained was a coating of 10% zein solids on the neotame encapsulated with capsul starch (2.42% neotame). A sample of 200.0 g was collected. The particle size distribution for the product was: 0.6% 40 mesh, 2.1% 100 mesh, 2.6% 140 mesh, 79.8% 200 mesh and 16.0% greater than 200 mesh.

### EXAMPLE 10

Encapsulation of Neotame with Capsul Starch/Polyvinyl Acetate

A 15% solution of polyvinyl acetate in methanol was prepared as the spray solution for a Wurster column. Neotame (400.0 g) encapsulated with capsul starch from Example 8 was added to the bowl of the Wurster column. When the contents of the bowl reached a temperature of 140° F., the 15% polyvinyl acetate solution was applied to the contents of the bowl. The spray rate was maintained around 5.0 g/min, until 10% polyvinyl acetate solids was added to the contents in the bowl.

The product obtained was a coating of 10% polyvinyl acetate solids on the neotame encapsulated with capsul starch (2.29% neotame). A sample of 200.0 g was collected. The particle size distribution for the product was: 1.1% 40 mesh, 3.5% 100 mesh, 3.0% 140 mesh, 60.9% 200 mesh and 32.4% greater than 200 mesh.

### EXAMPLE 11

Encapsulation of Neotame with Capsul Starch/Hydroxypropylmethyl Cellulose

A 10% solution of hydroxypropylmethyl cellulose in water was prepared as the spray solution for a Wurster column. Neotame (400.0 g) encapsulated with capsul starch from Example 8 was added to the bowl of the Wurster column. When the contents of the bowl reached a temperature of 170° F., the 10% hydroxypropylmethyl cellulose solution was applied to the contents of the bowl. The spray rate was maintained around 5.0 g/min, until 10% hydroxypropylmethyl cellulose solids was added to the contents in the bowl. The product obtained was a coating of 10% hydroxypropylmethyl cellulose solids on the neotame encapsulated with capsul starch (2.14% neotame). A sample of 200.0 g was collected. The particle size distribution for the product was: 4.6% 40 mesh, 31.7% 100 mesh, 11.3% 140 mesh, 15.6% 200 mesh and 37.8% greater than 200 mesh.

### EXAMPLE 12

Encapsulation of Neotame with HiCap Starch

HiCap starch (3 kg) (National Starch & Chemical, Bridgewater, N.J.) was mixed into 7 kg water. The mixture was heated to 190° F. and held for one hour. After one hour, the mixture was cooled to 150° F. Then 36.1 g neotame was added to 4.02 kg starch solution. The resultant mixture was spray dried using a spray drier. The inlet air temperature ranged form 160° C.-330° C., and the outlet temperature ranged form 90° C.-120° C. The final product was neotame encapsulated with HiCap starch (2.73 wt/wt % neotame). The particle size distribution for the product was: 2.5% 40 mesh, 8.0% 100 mesh, 2.6% 140 mesh and 87.1% greater than 200 mesh.

### EXAMPLE 13

Encapsulation of Neotame with HiCap Starch/Hydroxypropylmethyl Cellulose

A 10% solution of hydroxypropylmethyl cellulose in water was prepared as the spray solution for a Wurster column. Neotame (400.0 g) encapsulated with HiCap starch from Example 12 was added to the bowl of the Wurster column. When the contents of the bowl reached a temperature of 170° F., the 10% hydroxypropylmethyl cellulose solution was applied to the contents of the bowl. The spray rate was maintained around 5.0 g/min, until 10% hydroxypropylmethyl cellulose solids was added to the contents in the bowl. The product obtained was a coating of 10% hydroxypropylmethyl cellulose solids on the neotame encapsulated with HiCap starch (2.30% neotame). A sample of 200.0 g was collected. The particle size distribution for the product was: 5.4% 40 mesh, 34.2% 100 mesh, 9.5% 140 mesh, 36.8% 200 mesh and 14.8% greater than 200 mesh.

### EXAMPLE 14

Stability of Encapsulated Forms of Neotame

Chewing gum compositions using the encapsulated neotame compositions of Examples 4-12 were made in accordance with Example 2, in order to provide chewing gum samples with 100 ppm neotame. Each of the chewing gums was assayed at 4 and 8 weeks time storage time (75° F., 55% relative humidity) for the amount of neotame present. A chewing gum comprising neotame without the advantage of being encapsulated is included as a control.

TABLE 5
Shelf-life stability enhancement of neotame.

| | % neotame remaining |
|---|---|
| example (encapsulant) | at 8 weeks |
| control | 83 |
| single coating: | |
| 4 (dextrose) | 84 |
| 8 (capsul starch) | 89 |
| 12 (HiCap starch) | 87 |
| double coating: | |
| 5 (dextrose/polyvinylacetate) | 94 |
| 6 (dextrose/ | 100 |
| hydroxypropylmethylcellulose) | |
| 7 (dextrose/zein) | 96 |
| 9 (capsul starch/zein) | 91 |
| 10 (capsul starch/ | 94 |
| polyvinylacetate) | |
| 11 (capsul starch/ | 99 |
| hydroxypropylmethylcellulose) | |

As Table 5 illustrates, the amount of neotame which remains at 4 and 8 weeks time is greater than that provided by the neotame control. Furthermore, the enhancement of stability of neotame is dependent on the type of agent used, since the range of neotame loss at the 8 week storage time varies between around 0% to around 17%. The use of hydroxypropylmethylcellulose as an encapsulation material affords the greatest stability enhancement, in which case the enhancement is around 25% measured at the 8 week storage time.

Sensory Evaluation

The sensory profiling of chewing gum samples was carried out using the Spectrum Method of Descriptive Analysis (Meilgaard, M., Civille, G. V., Carr, B. T, 1999. Sensory Evaluation Techniques, 3^{rd} Ed. CRC Press, New York, p. 173-229). Extensive sensory training was conducted in order to familiarize the panel, consisting of 6-8 individuals, with a product category, exposing the panel to the flavor attributes of the category and in-depth practice by the panelists in the use of a fifteen point scale for describing intensity differences. Once trained, the method enabled the trained panelists to indicate the sensory intensity of either sweetness intensity or flavor intensity in a universal context, where 0 indicates “none” of the attribute present, 2 approximates “threshold” intensities, 5 “slight or low” level, 7.5 “moderate” intensity, 10 “strong” and 15 “extreme”.

Chewing of the gums was initiated by the panel leader while starting a timer. As the time intervals 0.25, 0.5, 1.0, 2.0, 3.0, 4.0, 6.0, 8.0, 10.0, 12.0, 16.0, and 20.0 minutes approached, the panel leader gave panelists a five second warning and then called out the time to rate the attributes. To minimize fatigue, 3-4 samples were evaluated during one session. Samples were assessed in duplicate, presented in a balanced order, unwrapped in two ounce plastic cups, and randomly coded with three-digit numbers. The panelists were given a ten minute break between samples to minimize carry-over effects. Water, Mott's Natural Applesauce and unsalted soda crackers were given as palate cleansers.

The data was analyzed for standard ANOVA for across sample comparison of attributes at each chew time. Data was then plotted as a graph of intensities vs. chewing time yielding either a sweetness or flavor profile for the entire chew time.

Other variations and modification of this invention will be obvious to those skilled in this art. This invention is not to be limited except as set forth in the following claims.

What is claimed is:

1. A chewing gum composition comprising N-[N-(3,3-dimethylbutyl)-L-α-aspartyl]-L-phenylalanine 1-methyl ester in an amount effective to sweeten said chewing gum composition.

2. The chewing gum composition according to claim 1, wherein said N-[N-(3,3-dimethylbutyl)-L-α-aspartyl]-L-phenylalanine 1-methyl ester is in an amount of from about 10 to about 1600 parts per million.

3. The chewing gum composition according to claim 2, wherein said N-[N-(3,3-dimethylbutyl)-L-α-aspartyl]-L-phenylalanine 1-methyl ester is in an amount of from about 40 to about 600 parts per million.

4. The chewing gum composition according to claim 3, wherein said N-[N-(3,3-dimethylbutyl)-L-α-aspartyl]-L-phenylalanine 1-methyl ester is in an amount of from about 100 to about 250 parts per million.

5. A chewing gum composition according to claim 1, further comprising one or more additional sweeteners.

6. The chewing gum composition according to claim 5, wherein said one or more additional sweeteners is selected from the group consisting of xylose, ribulose, glucose, mannose, dextrin, galactose, fructose, sucrose, maltose, invert sugar, partially hydrolyzed starch, corn syrup solids, sorbitol, xylitol, mannitol, galactitol, maltitol, isomalt, maltodextrins, hydrogenated starch hydrolysates, hydrogenated hexoses, hydrogenated disaccharides, dihydroxychalcones, monellin, steviosides, glycyrrhizins, dihydroflavenol, L-aminodicarboxylic acids, aminoalkenoic acid ester amides, saccharin, acesulfame, and saccharin and acesulfame salts, aspartame, alitame, chlorodeoxysugar derivatives of sucrose, thaumatin derivatives, and mixtures thereof.

7. The chewing gum composition according to claim 5, wherein said N-[N-(3,3-dimethylbutyl)-L-α-aspartyl]-L-phenylalanine 1-methyl ester is in an amount of from about 0.1 ppm to about 1200 parts per million.

8. The chewing gum composition according to claim 1 further comprising a chewable gum base.

9. The chewing gum composition according to claim 8, wherein said chewable gum base includes a resin which is selected from the group consisting of polyvinyl acetate and terpene resins.

10. The chewing gum composition according to claim 8, wherein said chewing gum base includes a fat or an oil which is selected from the group consisting of lard, tallow, soybean oil, cottonseed oil, hydrogenated and partially hydrogenated vegetable oils, cocoa butter, and combinations thereof.

11. The chewing gum composition according to claim 8, wherein said chewable gum base includes a wax which is selected from the group consisting of petroleum waxes, paraffin, candellia, carnuba, beeswax, polyethylene, and combinations thereof.

12. The chewing gum composition according to claim 8, wherein said chewable gum base includes an elastomer which is selected from the group consisting of polyisobutylene, isobutylene-isoprene copolymer, styrene butadiene rubber, chicle, and combinations thereof.

13. The chewing gum composition according to claim 8 further comprising a softener which is selected from the group consisting of glycerin, lecithin, glycerol monostearate, glycerol triacetate, and combinations thereof.

14. The chewing gum composition according to claim 8, wherein said chewable gum base includes an inorganic filler which is selected from the group consisting of calcium carbonate, magnesium carbonate, talc, dicalcium phosphate, and combinations thereof.

15. The chewing gum composition according to claim 8 further comprising a texturizer which is selected from the group consisting of lycasin, glycerin, mannitol, or combinations thereof.

16. The chewing gum composition according to claim 8 further comprising a bulking or binding agent selected from the group consisting of dextrose, maltodextrin, lactose, inulin, cellulose, cellulose derivatives, gelatin, xanthan, guar, pectins, locust bean, alginates, agar, carrageenans, gum acacia, tara gum, karaya gum, gellan gum, gurcellaran, tragacanth, guar gum hydrolysate, ghatti, microcrystalline cellulose, carbomethyl-cellulose, hollocellulose, cellulose gel, polydextrose, maltodextrose, isomalulose, polymaltose, arabinogalactan, palatinose, starches, starch hydrolysates, hydrogenated starch hydrolysates, partially hydrolyzed starch, dextrins, hydrogenated hexoses, fructooligosaccharides, sorbitol, xylitol, mannitol, maltitol, galactitol, isomalt, and mixtures thereof.

17. The chewing gum composition according to claim 8 further comprising an organic acid selected from the group consisting of citric acid, malic acid, tartaric acid, and mixtures thereof.

18. The chewing gum composition according to claim 8 further comprising a flavor selected from the group consisting of essential oils, synthetic flavors, oils derived from plants and fruits, citrus oils, fruit essences, peppermint oil, spearmint oil, clove oil, oil of wintergreen, anise, cinnamon, tutti frutti, strawberry, raspberry, lemon, orange, artificial flavorings, and combinations thereof.

19. The chewing gum composition according to claim 1, wherein between 6 and 10 minutes chewing time, the average sweetness intensity loss rate is less than 0.3 intensity units per minute.

20. The chewing gum composition according to claim 1, wherein between 10 and 20 minutes chewing time, the average sweetness intensity loss rate is less than 0.15 intensity units per minute.

21. The chewing gum composition according to claim 1, wherein a flavor is present in an amount effective to produce a full-flavored chewing gum composition and wherein between 4 and 20 minutes chewing time, the average flavor intensity loss rate is less than 0.1 intensity units per minute.

22. The chewing gum composition according to claim 1, wherein an amount of flavor used is at least 50% less than the amount of flavor in a full-flavored chewing gum composition, whereby a level of flavor intensity comparable to a full-flavored chewing gum composition is maintained.

23. The chewing gum composition according to claim 1 further comprising a rapid release sweetener.

24. The chewing gum composition according to claim 23, wherein the rapid release sweetener has a sweetness intensity maximum within the first 2 minutes of chewing.

25. The chewing gum composition according to claim 23, wherein the rapid release sweetener is selected from the group consisting of sucrose, mannitol, fructose, high fructose corn syrup, sorbitol, dextrose, corn syrup solids, hydrogenated starch hydrolysates, invert sugar, fructose, xylitol, and combinations thereof.

26. The chewing gum composition according to claim 1, wherein said N-[N-(3,3-dimethylbutyl)-L-α-aspartyl]-L-phenylalanine 1-methyl ester is encapsulated by or admixed with an agent.

27. The chewing gum composition according to claim 26, wherein the agent is selected from the group consisting of cellulose, cellulose derivatives, hydroxypropylmethyl cellulose, stearic acid, shellac, polyethylene wax 500, zein, sterine 27, alginates, gelatin, starches, proteins, sugars, sugar alcohols, complex carbohydrates, gums, hydrocolloids, gellan gum, polydextrose, polywax, hydrogenated starch hydrolyzate, polyvinyl acetate, xanthan gum, carrageenan, dextrose, malic acid, maltodextrin, gum arabic and combinations thereof.

28. A process for sweetening a chewing gum composition comprising the step of:
including N-[N-(3,3-dimethylbutyl)-L-α-aspartyl]-L-phenylalanine 1-methyl ester in a chewing gum composition in an amount effective to sweeten said chewing gum composition.

29. The process of sweetening a chewing gum composition according to claim 28, wherein said N-[N-(3,3-dimethylbutyl)-L-α-aspartyl]-L-phenylalanine 1-methyl ester is included in an amount of from about 10 to about 1600 parts per million.

30. The process of sweetening a chewing gum composition according to claim 29, wherein said N-[N-(3,3-dimethylbutyl)-L-α-aspartyl]-L-phenylalanine 1-methyl ester is included in an amount of from about 40 to about 600 parts per million.

31. The process of sweetening a chewing gum composition according to claim 30, wherein said N-[N-(3,3-dimethylbutyl)-L-α-aspartyl]-L-phenylalanine 1-methyl ester is included in an amount of from about 100 to about 250 parts per million.

32. The process of sweetening a chewing gum composition according to claim 28 further comprising the step of including one or more additional sweeteners in said chewing gum composition.

33. The process of sweetening a chewing gum composition according to claim 32, wherein said one or more additional sweeteners is selected from the group consisting of xylose, ribulose, glucose, mannose, dextrin, galactose, fructose, sucrose, maltose, invert sugar, partially hydrolyzed starch, corn syrup solids, sorbitol, xylitol, mannitol, galactitol, maltitol, isomalt, maltodextrins, hydrogenated starch hydrolysates, hydrogenated hexoses, hydrogenated disaccharides, dihydroxychalcones, monellin, steviosides, glycyrrhizins, dihydroflavenol, L-aminodicarboxylic acids, aminoalkenoic acid ester amides, saccharin, acesulfame, and saccharin and acesulfame salts, aspartame, alitame, chlorodeoxysugar derivatives of sucrose, thaumatin derivatives, and mixtures thereof.

34. The process of sweetening a chewing gum composition according to claim 32, wherein said N-[N-(3,3-dimethylbutyl)-L-α-aspartyl]-L-phenylalanine 1-methyl ester is included in an amount of from about 0.1 ppm to about 1200 parts per million.

35. The process of sweetening a chewing gum composition according to claim 28, wherein said chewing gum composition comprises a chewable gum base.

36. The process of sweetening a chewing gum composition according to claim 35, wherein said chewable gum base includes a resin which is selected from the group consisting of polyvinyl acetate and terpene resins.

37. The process of sweetening a chewing gum composition according to claim 35, wherein said chewing gum base includes a fat or an oil which is selected from the group consisting of lard, tallow, soybean oil, cottonseed oil, hydrogenated and partially hydrogenated vegetable oils, cocoa butter, and combinations thereof.

38. The process of sweetening a chewing gum composition according to claim 35, wherein said chewable gum base includes a wax which is selected from the group consisting of petroleum waxes, paraffin, candellia, carnuba, beeswax, polyethylene, and combinations thereof.

39. The process of sweetening a chewing gum composition according to claim 35, wherein said chewable gum base includes an elastomer which is selected from the group consisting of polyisobutylene, isobutylene-isoprene copolymer, styrene butadiene rubber, chicle, and combinations thereof.

40. The process of sweetening a chewing gum composition according to claim 35, wherein said chewing gum composition further comprises a softener which is selected from the group consisting of glycerin, lecithin, glycerol monostearate, glycerol triacetate, and combinations thereof.

41. The process of sweetening a chewing gum composition according to claim 35, wherein said chewable gum base includes an inorganic filler which is selected from the group consisting of calcium carbonate, magnesium carbonate, talc, dicalcium phosphate, and combinations thereof.

42. The process of sweetening a chewing gum composition according to claim 35, wherein said chewing gum composition further comprises a texturizer which is selected from the group consisting of lycasin, glycerin, mannitol, or combinations thereof.

43. The process of sweetening a chewing gum composition according to claim 35, wherein said chewing gum composition further comprises a bulking or binding agent selected from the group consisting of dextrose, maltodextrin, lactose, inulin, cellulose, cellulose derivatives, gelatin, xanthan, guar, pectins, locust bean, alginates, agar, carrageenans, gum acacia, tara gum, karaya gum, gellan gum, gurcellaran, tragacanth, guar gum hydrolysate, ghatti, microcrystalline cellulose, carbomethyl-cellulose, hollocellulose, cellulose gel, polydextrose, maltodextrose, isomalulose, polymaltose, arabinogalactan, palatinose, starches, starch hydrolysates, hydrogenated starch hydrolysates, partially hydrolyzed starch, dextrins, hydrogenated hexoses, fructooligosaccharides, sorbitol, xylitol, mannitol, maltitol, galactitol, isomalt, and mixtures thereof.

44. The process of sweetening a chewing gum composition according to claim 35, wherein said chewing gum composition further comprises an organic acid selected from the group consisting of citric acid, malic acid, tartaric acid, and mixtures thereof.

45. The process of sweetening a chewing gum composition according to claim 35, wherein said chewing gum composition further comprises a flavor selected from the group consisting of essential oils, synthetic flavors, oils derived from plants and fruits, citrus oils, fruit essences, peppermint oil, spearmint oil, clove oil, oil of wintergreen, anise, cinnamon, tutti frutti, strawberry, raspberry, lemon, orange, artificial flavorings, and combinations thereof.

46. A process of extending the sweetness of a chewing gum composition comprising the step of:
sweetening a chewing gum composition with N-[N-(3,3-dimethylbutyl)-L-α-aspartyl]-L-phenylalanine 1-methyl ester according to claim 28.

47. A process of extending the flavor of a chewing gum composition comprising the step of:
sweetening a chewing gum composition with N-[N-(3,3-dimethylbutyl)-L-α-aspartyl]-L-phenylalanine 1-methyl ester according to claim 28.

48. A process of reducing the amount of flavor ingredient required to produce a full-flavored chewing gum composition and to maintain a level of flavor intensity comparable to a full-flavored chewing gum composition comprising the step of:
sweetening a chewing gum composition with N-[N-(3,3-dimethylbutyl)-L-α-aspartyl]-L-phenylalanine 1-methyl ester according to claim 28.

49. The process of sweetening a chewing gum composition according to claim 28, wherein said chewing gum composition further comprises a rapid release sweetener.

50. The process of sweetening a chewing gum composition according to claim 49, wherein the rapid release sweetener has a sweetness intensity maximum within the first 2 minutes of chewing.

51. The process of sweetening a chewing gum composition according to claim 49, wherein the rapid release sweetener is selected from the group consisting of sucrose, mannitol, fructose, high fructose corn syrup, sorbitol, dextrose, corn syrup solids, hydrogenated starch hydrolysates, invert sugar, fructose, xylitol, and combinations thereof.

52. The process of sweetening a chewing gum composition according to claim 28, wherein said N-[N-(3,3-dimethylbutyl)-L-α-aspartyl]-L-phenylalanine 1-methyl ester is encapsulated by or admixed with an agent.

53. The process of sweetening a chewing gum composition according to claim 52, wherein the agent is selected from the group consisting of cellulose, cellulose derivatives, hydroxypropylmethyl cellulose, stearic acid, shellac, polyethylene wax 500, zein, sterine 27, alginates, gelatin, starches, proteins, sugars, sugar alcohols, complex carbohydrates, gums, hydrocolloids, gellan gum, polydextrose, polywax, hydrogenated starch hydrolyzate, polyvinyl acetate, xanthan gum, carrageenan, dextrose, malic acid, maltodextrin, gum arabic and combinations thereof.
